(19) United States
(12) Patent Application Publication
(10) Pub. No.: US 2010/0186925 A1
(43) Pub. Date: Jul. 29, 2010

(54) RADIATOR

(75) Inventors: Kazuyuki Suzuki, Osaka (JP); Taira Ozaki, Osaka (JP); Akihito Oonishi, Osaka (JP); Shigeru Yamamoto, Osaka (JP)

Correspondence Address: GLOBAL IP COUNSELORS, LLP, 1233 20TH STREET, NW, SUITE 700, WASHINGTON, DC, 20036-2680, US

(73) Assignee: Komatsu Ltd., Minato-ku, Tokyo (JP)

(21) Appl. No.: 12/668,709

(22) PCT Filed: Sep. 4, 2008
(86) PCT No.: PCT/JP2008/065967

§ 371 Date: Jan. 12, 2010

(30) Foreign Application Priority Data
Sep. 11, 2007 (JP) 2007-235476
Sep. 1, 2008 (JP) 2008-224133
Sep. 1, 2008 (JP) 2008-224134

(51) Int. Cl. B60H 1/00; F28D 1/00

(52) U.S. Cl. 165/41; 165/148; 165/51

(57) ABSTRACT

A radiator includes a heat exchanger, an upper auxiliary tank, a lower auxiliary tank, an upper main tank and a lower main tank. The upper auxiliary tank is mounted on an upper surface of the heat exchanger. The lower auxiliary tank is mounted on a lower surface of the heat exchanger. The upper main tank is arranged at the substantially same height as the upper auxiliary tank and at an offset position relative to the upper auxiliary tank in the plan view. The upper main tank is connected to the upper auxiliary tank via a coolant water conduit pipe, and has a coolant water inlet on a lower surface thereof. The lower main tank is arranged under the upper main tank at an offset position relative to the upper main tank in the plan view, and is connected to the lower auxiliary tank.

### CROSS-REFERENCE TO RELATED APPLICATIONS

This national phase application claims priority to Japanese Patent Application No. 2007-235476 filed on Sep. 11, 2007, Japanese Patent Application No. 2008-224133 filed on Sep. 1, 2008, and Japanese Patent Application No. 2008-224134 filed on Sep. 1, 2008. The entire disclosures of Japanese Patent Application Nos. 2007-235476, 2008-224133 and 2008-224134 are hereby incorporated herein by reference.

### TECHNICAL FIELD

The present invention relates to a radiator including a radiator core.

### BACKGROUND ART

A conventional work vehicle such as bulldozer is equipped with a module type radiator that is divided into a plurality of core units so that if the radiator core is partially damaged by vibration, shock and the like the damaged part can be simply replaced. As for this type of radiator, for example, International Publication Pamphlet WO2005/008162 discloses a radiator that facilitates reduction of space for replacing its core unit, simplification of replacing its core unit, and the like.

International Publication Pamphlet WO2005/008162 discloses module type radiators 100 and 100A shown in FIGS. 8(a) and 8(b). The module type radiators 100 and 100A shown in FIGS. 8(a) and 8(b), respectively, have the same basic configuration. Therefore, each of elements having a same function is respectively attached with the same reference numerals in these Figures.

Each of the radiators 100 and 100A shown in FIGS. 8(a) and 8(b), respectively, includes upper and lower main tanks 101 and 102 that are arranged on the upper and lower sides, and a plurality of core units 106, each of which includes upper and lower auxiliary tanks 103 and 104 that are arranged on the upper and lower sides to interpose a heat exchanging portion 105 between the upper and lower auxiliary tanks 103 and 104. The plurality of core units 106 are arranged in parallel to each other on the lower main tank 102. The upper main tank 101 is arranged in a position that is offset toward the vehicle front side relative to the lower main tank 102 in the plan view. In the radiators 100 and 100A shown in FIGS. 8(a) and 8(b), respectively, since the upper main tank 101 is arranged in the offset position relative to the lower main tank 102 in the plan view, the core units 106 can be removed/inserted from directly above. For this reason, it is possible to facilitate reduction of space for replacing the core unit, simplification of the replacement, and the like.

In this case, in the radiators 100 and 100A shown in FIGS. 8(a) and 8(b), respectively, the upper auxiliary tank 103 in the core unit 106 is arranged at a position lower than the upper main tank 101. In the radiator 100 shown in FIG. 8(a), the upper surface of the upper auxiliary tank 103 and the side surface of the upper main tank 101 are connected to each other by a coolant water conduit pipe 107. In the radiator 100A shown in FIG. 8(b), the side surface of the upper auxiliary tank 103 and the lower surface of the upper main tank 101 are connected by a coolant water conduit pipe 107A.

On the other hand, recently, in work vehicles such as bulldozer, improvement in cooling performance of radiator is strongly required. In terms of arrangement relationship with peripheral equipments, core airflow resistance and the like, it is conceivable that the best way for improving cooling performance is to increase the height of its core unit (the height of the heat exchanging portion). In the case where the height of the core unit is increased, if the entire height of the radiator is increased, the engine compartment height will be increased. This may adversely affect frontward visibility. For this reason, it is necessary to increase the height of the core unit without increasing the entire height of the radiator in a result.

However, the radiators 100 and 100A shown in FIGS. 8(a) and 8(b), respectively, arrangement space for the upper main tank 101 is required above the core unit 106. For this reason, only increasing the entire height of the radiator 100 can increase the height of the core unit 106. Accordingly, from the viewpoint of the aforementioned frontward visibility issue, there is a problem in that the height of the core unit 106 cannot be increased.

Even in the case where radiators include a core unit having the same size, if air bubbles in coolant water are circulated in the cooling pipe path formed in a radiator, cooling efficiency of the radiator may be reduced by circulation of air bubbles. For this reason, even if the height of core units in a radiator could be increased as high as possible, it is very important to prevent circulation of air bubbles contained in coolant water in terms of ensuring the cooling performance of the radiator.

### SUMMARY OF THE INVENTION

It is an object of the present invention is to provide a radiator capable of effectively improving the cooling performance without increasing the entire size of the radiator.

A radiator according to a first aspect of the present invention includes a heat exchanger, an upper auxiliary tank, a lower auxiliary tank, an upper main tank, and a lower main tank. The upper auxiliary tank is mounted on the upper surface of the heat exchanger. The lower auxiliary tank is mounted on the lower surface of the heat exchanger so that the heat exchanger is interposed between the lower auxiliary tank and the upper auxiliary tank. The upper main tank is arranged at the substantially same height as the upper auxiliary tank and is arranged at an offset position relative to said upper auxiliary tank not to overlap said upper auxiliary tank in the plan view. The upper main tank is connected to the upper auxiliary tank via a coolant water conduit pipe. The upper main tank has a coolant water inlet on the lower surface the upper main tank. The lower main tank is arranged under the upper main tank at an offset position relative to the upper main tank in the plan view. The lower main tank is connected to the lower auxiliary tank.

The coolant water inlet for feeding coolant water into the upper main tank is thus arranged in the lower part of the upper main tank so that the coolant water is fed from the bottom of the upper main tank. Therefore, it is possible to effectively prevent that air enters the coolant water, and to effectively prevent reduction of the cooling performance of the radiator.

In addition, since the upper main tank is arranged at the substantially same height as the upper auxiliary tank, and the upper main tank and the upper auxiliary tank are connected to each other via the coolant water conduit pipe, piping space is not required that has been required above each upper auxiliary tank in the past. For this reason, even in the case where the radiator according to the present invention has the same entire height as the known module type radiator, the height of its core unit can be greater. Therefore, it is possible to improve the cooling performance.

In the radiator according to a second aspect of the present invention, in the radiator according to the first aspect of the present invention, the lower surface of the upper main tank is arranged at the substantially same height as the lower surface of the upper auxiliary tank. In addition to this, the upper surface of the upper main tank is arranged at a higher position than the upper surface of the upper auxiliary tank.

Thus, even in the case where the upper main tank and the upper auxiliary tank are arranged at the substantially same height, since the upper surface of the upper main tank is arranged higher than the upper surface of the upper auxiliary tank, air bubbles contained in the coolant water that flowed into the upper main tank remain on the upper main tank side. Therefore, it is possible to effectively prevent that coolant water containing air bubbles circulates from the upper main tank toward the upper auxiliary tank.

In the radiator according to a third aspect of the present invention, in the radiator according to the first or second aspect of the present invention, the upper main tank has a coolant water outlet that discharges coolant water in the upper auxiliary tank via the coolant water conduit pipe. In addition to this, the upper main tank further includes a baffle that is arranged in proximity to the coolant water outlet to suppress passage of air bubbles through the coolant water outlet.

Thus, it is easily possible to suppress circulation of coolant water that contains air bubbles by means of the baffle that is arranged in the upper main tank. Accordingly, it is possible to suppress that coolant water that contains air bubbles flows from the upper main tank into the upper auxiliary tank. Therefore, it is possible to prevent reduction of the cooling efficiency of the heat exchanger.

In the radiator according to a fourth aspect of the present invention, in the radiator according to the first or second aspect of the present invention, the upper main tank is arranged at an offset position toward an engine side relative to the lower main tank.

Accordingly, coolant water that is warmed in an engine can flow into the upper main tank, which is arranged in proximity to the engine. For this reason, the length of the coolant water conduit pipe can be minimized, and the height of the heat exchanger can be greater. Therefore, it is possible to improve the cooling efficiency and to provide efficient arrangement of components in the engine compartment.

In the radiator according to a fifth aspect of the present invention, in the radiator according to the first or second aspect of the present invention, the radiator includes a plurality of core units, each of which includes the heat exchanger, the upper auxiliary tank and the lower auxiliary tank so that the radiator is configured in a module.

Accordingly, even when one core unit of the plurality of modularized core units is replaced due to malfunction, since the upper main tank is arranged at the offset position in the plan view relative to the lower main tank, the core unit can be removed/inserted from directly above. Therefore, it is possible to facilitate reduction of space for replacing the core unit, simplification of the replacement, and the like.

A radiator according to a sixth aspect of the present invention includes a heat exchanger, an upper auxiliary tank, a lower auxiliary tank, an upper main tank, and a lower main tank. The upper auxiliary tank is mounted on the upper surface of the heat exchanger. The lower auxiliary tank is mounted on the lower surface of the heat exchanger so that the heat exchanger is interposed between the lower auxiliary tank and the upper auxiliary tank. The upper main tank is arranged at the substantially same height as said upper auxiliary tank and is arranged at an offset position relative to said upper auxiliary tank not to overlap said upper auxiliary tank in the plan view. The side surface of the upper main tank is connected to the side surface of the upper auxiliary tank via a coolant water conduit pipe. The lower main tank is arranged under the upper main tank at an offset position relative to the upper main tank in the plan view. The lower main tank is connected to the lower auxiliary tank.

Thus, piping space is unnecessary that has been required above each upper auxiliary tank in the past. For this reason, even in the case where the radiator according to the present invention has the same entire height as the known radiator, the height of its core unit can be greater. As a result, it is possible to improve the cooling performance of the radiator.

In the radiator according to a seventh aspect of the present invention, in the radiator according to the sixth aspect of the present invention, the radiator includes a plurality of core units, each of which includes the heat exchanger, the upper auxiliary tank and the lower auxiliary tank so that the radiator is configured in a module.

Accordingly, even when one of core unit among the plurality of modularized core units is replaced due to malfunction, since the upper main tank is arranged at the offset position in the plan view relative to the lower main tank, the core unit can be removed/inserted from directly above. Therefore, it is possible to facilitate reduction of space for replacing the core unit, simplification of the replacement, and the like.

In the radiator according to an eighth aspect of the present invention, in the radiator according to the sixth or seventh aspect of the present invention, the coolant water conduit pipe is a straight pipe.

Since a straight pipe is provided as the coolant water conduit pipe that connects the side surface of the upper auxiliary tank in the core unit and the side surface of the upper main tank to each other, the height of the core unit can be maximized even in the case where the thus-configured radiator has the same height as the known radiator.

In the radiator according to a ninth aspect of the present invention, in the radiator according to the sixth or seventh aspect of the present invention, the radiator is installed in a vehicle. In addition to this, the upper main tank is mounted to a vehicle body frame that composes the frame of the vehicle.

In the case where this module type radiator is installed in a vehicle, since the upper main tank is thus mounted to a vehicle body frame that composes the frame of the vehicle, it is possible to firmly keep the arrangement of the upper main tank.

In the radiator according to a tenth aspect of the present invention, in the radiator according to the sixth or seventh aspect of the present invention, the radiator is accommodated in an engine compartment of a vehicle. In addition to this, the upper main tank is configured integrally with an exterior cover that composes the roof of the engine compartment.

In the case where radiators are accommodated in an engine compartment of a vehicle, it is generally necessary to arrange a gap between an exterior cover that composes the roof of the engine compartment, and an upper main tank. However, according to the present invention, since the upper main tank is configured integrally with the exterior cover, it is possible to further increase the height of core unit corresponding to the gap. Therefore, it is possible to further improve the cooling performance of the radiator.

### BRIEF DESCRIPTION OF DRAWINGS

FIG. 1 is a schematic side view of a bulldozer equipped with a module type radiator according to one embodiment of the present invention.

FIG. 2 is a plan view of the radiator according to this embodiment in an installation state.

FIG. 3 is a front view of the radiator according to this embodiment in the installation state.

FIG. 4 is a side view of the radiator according to this embodiment in the installation state.

FIG. 5 is a cross-sectional view showing an internal configuration of an upper main tank included in the radiator according to this embodiment.

FIG. 6 is an illustrative view of a radiator according to a modified embodiment.

FIG. 7 is an illustrative view showing the configuration of a modified radiator according to another embodiment of the present invention.

FIG. 8 is an illustrative view showing a known radiator.

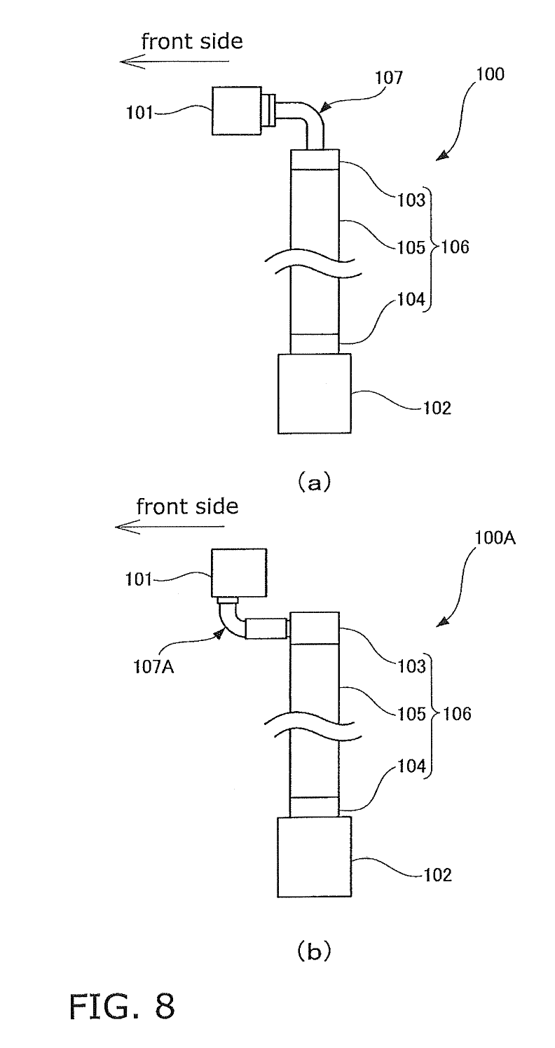

### DETAILED DESCRIPTION OF THE PREFERRED EMBODIMENTS

The following description will describe a module type radiator according to an exemplary embodiment of the present invention with reference to drawings.

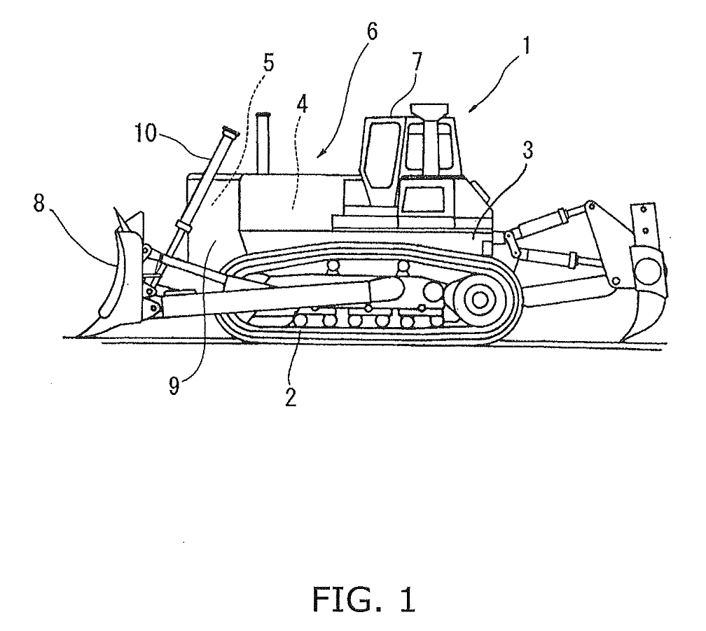

FIG. 1 is a schematic side view of a bulldozer equipped with a module type radiator according to one embodiment of the present invention. Frontward, rearward, rightward and leftward in the following description refer to frontward, rearward, rightward and leftward of the bulldozer.

In the bulldozer 1 shown in FIG. 1, an engine compartment 6 is disposed in a front part of a vehicle body unit 3 that includes track-type drive units 2. The engine compartment 6 accommodates an engine 4 and a module type radiator 5. An operator compartment 7 is disposed in a rear part of the vehicle body unit 3. Also, a blade 8 is disposed in front of the vehicle body unit 3. This blade 8 is moved upward and downward by left and right lift cylinders (only left cylinder is shown) 10 mounted on the vehicle body frame 9.

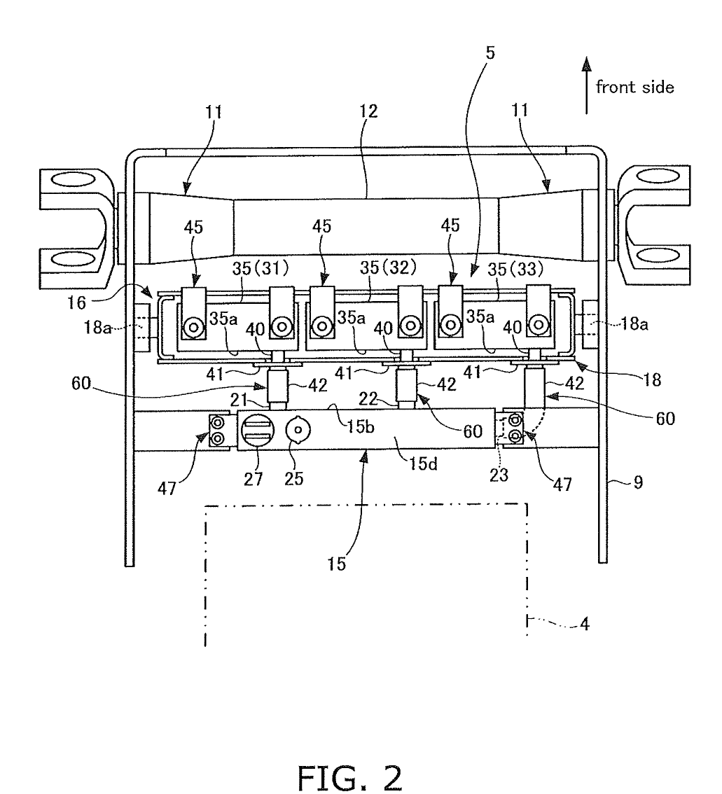

FIGS. 2, 3 and 4 are plan, front and side views of the radiator according to this embodiment in an installation state, respectively.

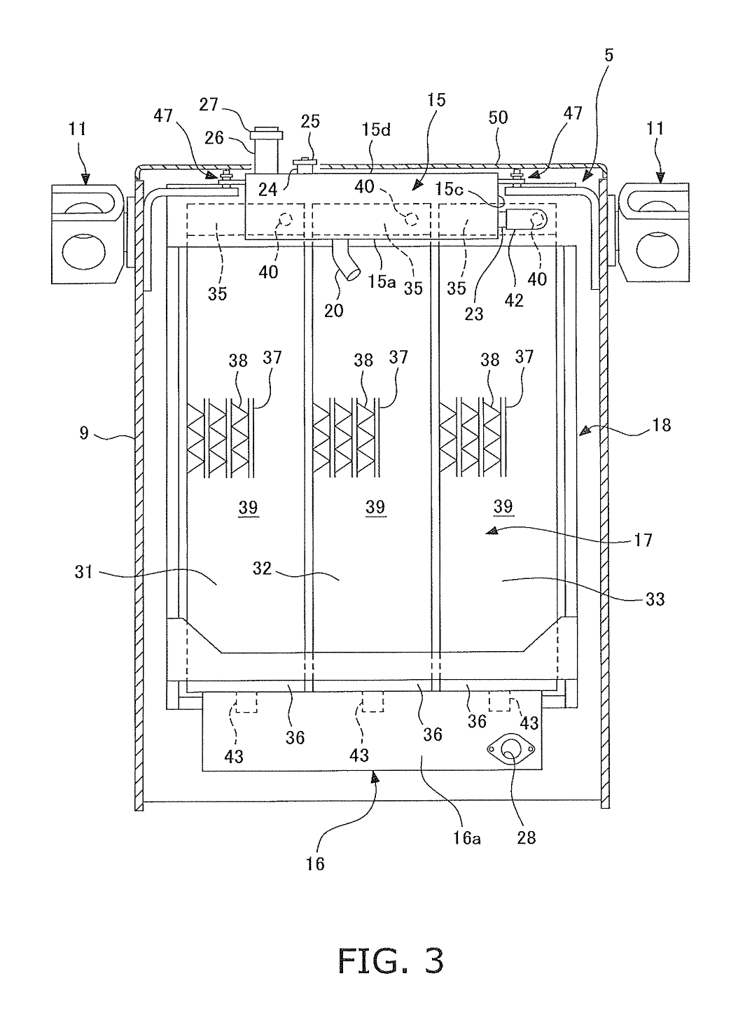

As shown in FIG. 2, the radiator 5 is arranged between a reinforcement member 12 and the engine 4. The reinforcement member 12 connects right and left supporting devices 11 to each other that support the right and left lift cylinders 10 (see FIG. 1). The radiator 5 includes upper and lower main tanks 15 and 16, a radiator core 17, and a radiator frame 18, as shown in FIG. 3. The upper and lower main tanks 15 and 16 are arranged in parallel to each other on the upper and lower sides of the radiator 5. The radiator core 17 is arranged on the lower main tank 16. The radiator frame 18 is formed in a frame shape that encloses the radiator core 17. The radiator core 17 is supported by the radiator frame 18 and the lower main tank 16.

The upper main tank 15 has a rectangular parallelepiped shape. The upper main tank 15 is spaced at a certain interval rearwards away from the radiator core 17, and is thus arranged at an offset position relative to the lower main tank 16 in the plan view. Specifically, the upper main tank 15 is arranged at an offset position toward an engine 4 side relative to the lower main tank 16. For this reason, a short pipe can be used for piping of coolant water that flows from the engine 4. A bottom plate 15a composes the lower surface of the upper main tank 15, and has a coolant water inlet 20 that extends downward. This coolant water inlet 20 is connected to a water jacket 63 of the engine 4 via a coolant water path (piping means) 61. The coolant water from the engine 4 flows into the upper main tank 15 through the coolant water inlet 20. Since the coolant water thus flows into the upper main tank 15 through the coolant water inlet 20 that is arranged on the bottom plate 15a of the upper main tank 15, the coolant water is fed from the bottom of the upper main tank 15. Accordingly, it is possible to prevent that the coolant water contains air.

As shown in FIG. 2, a front plate 15b composes the front surface of the upper main tank 15, and has first and second coolant water outlets 21 and 22 that extend straightly frontward. As shown in FIG. 3, a right side plate 15c composes the right side surface of the upper main tank 15, and has a third coolant water outlet 23 that extends straightly rightward.

Also, a radiator cap attachment port 24 is arranged on an upper plate 15d of the upper main tank 15. A pressurizing radiator cap 25 with a ventilation valve is attached to the radiator cap attachment port 24. The base part of the radiator cap attachment port 24 is connected to a reservoir tank (not shown). Thus, the pressure in the radiator 5 is kept constant by the radiator cap 25. The coolant water flows between the upper main tank 15 and the reservoir tank in the pressurization by radiator cap 25 so that a required amount of coolant water is constantly hold in the radiator 5. As for air that collects in the interior upper part of the upper main tank 15, the collecting gas is discharged to outside air by operation of the ventilation valve of the radiator cap 25. Reference numerals 26 and 27 show a coolant water feed port and a feed cap, respectively. The coolant water feed port 27 is arranged on the upper surface of the upper main tank 15. Thus, the default water level in the coolant water feed port 27 is located higher than the upper main tank 15.

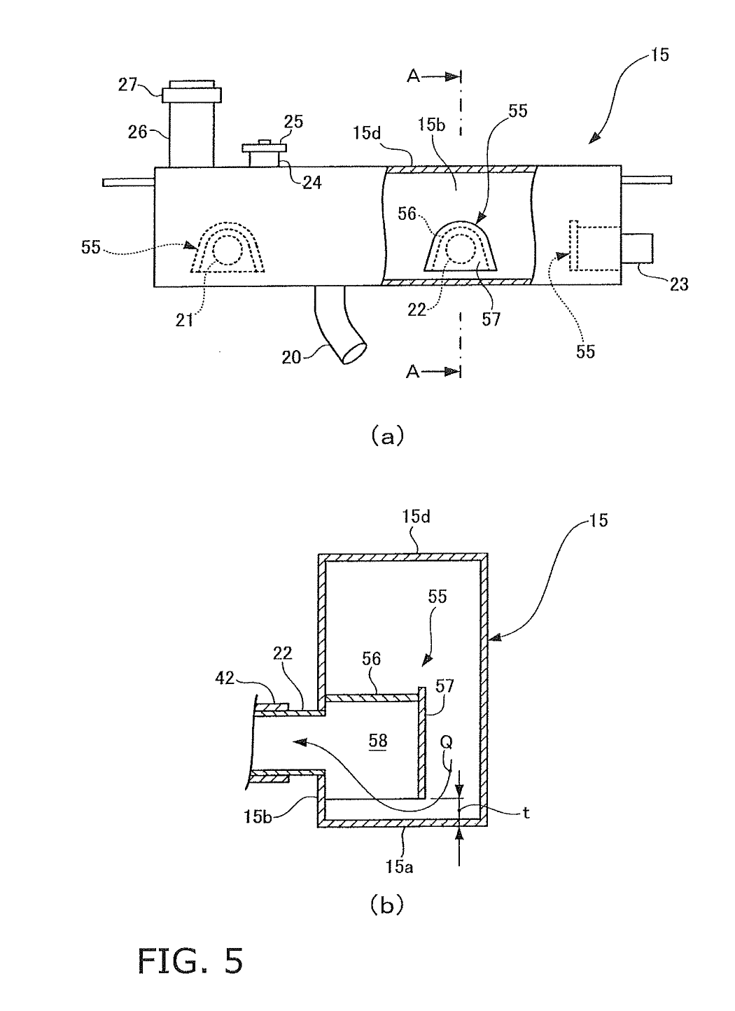

As shown in FIGS. 5(a) and 5(b), baffle devices (baffles) 55 are arranged correspondingly to coolant water outlets (outlets) 21 to 23 inside the upper main tank 15. Here, the baffle device 55 corresponding to the second coolant water outlet 22 is illustratively described. The baffle device 55 is spaced at a small gap t away from the bottom surface of the upper main tank 15, as shown in FIG. 5(b). The upper main tank 15 has partitioned chambers 58. Each of the partitioned chambers 58 is partitioned by front plate 15b, a sectionally arch-shaped upward convex plate 56 and an end wall plate 57, and is opened only downward and toward the second coolant water outlet 22 side. The baffle device 55 is configured so that the coolant water in the upper main tank 15 flows from the gap t into the second coolant water outlet 22 through the partitioned chamber 58 as shown by an arrow Q in FIG. 5(b). According to this embodiment, since the thus-configured baffle device 55 is arranged in the upper main tank 15, as for air bubbles that are entrained in the coolant water that flows into the upper main tank 15, it is possible to avoid feeding such air bubbles from the interior of the upper main tank 15 to the downstream side. Therefore, it is possible to more effectively prevent cooling performance degradation of the radiator due to circulation of the air bubbles that are entrained in the coolant water.

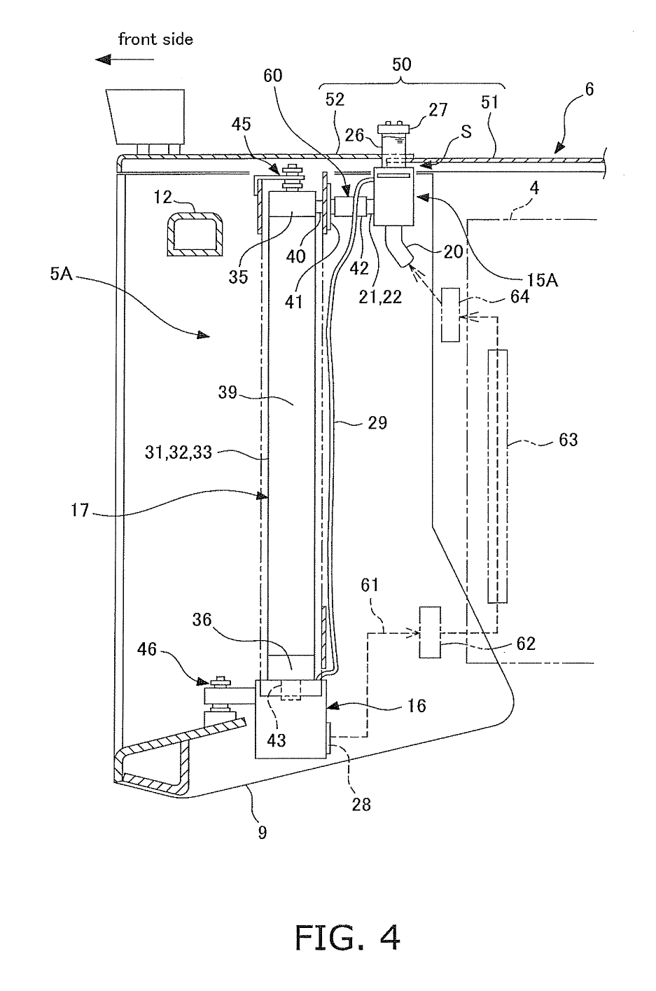

Similar to the upper main tank 15, the lower main tank 16 has a rectangular parallelepiped shape. The coolant water outlet 28 is arranged on a rear plate 16a. As shown in FIG. 4, the coolant water outlet 28 is connected to the water jacket 63 of the engine 4 via the coolant water path 61 and the water pump 62 so that the coolant water that has been cooled by the radiator core 17 is fed from the lower main tank 16 into the water jacket 63 of the engine 4, and is then fed into the coolant water inlet 20 through a thermostat 64.

As shown in FIG. 4, the upper main tank 15 and the lower main tank 16 are connected to each other by a communicating tube 29 (shown only in FIG. 4 for ease of illustration). Accordingly, even if air collects in the lower main tank 16, the air can be easily moved toward the upper main tank 15. The air that is moved toward the upper main tank 15 can be discharged by operation of the ventilation valve of the radiator cap 25. Thus, air in the radiator 5 can be easily removed. Therefore, it is possible to surely prevent air collection in the radiator 5. The communicating tube 29 is piped not to extend over the exposure surface of the radiator core 17 so that cooling air flow for the radiator core 17 is not be interrupted.

The radiator core 17 is composed of first, second and third core units 31, 32 and 33 that are arranged on the lower main tank 16 in parallel to each other from the left side to the right side as shown in FIG. 3. Each of the core units 31 to 33 includes upper and lower auxiliary tanks 35 and 36, and a heat exchanging portion (heat exchanger) 39. The upper and lower auxiliary tanks 35 and 36 has a low-profile rectangular parallelepiped shape, and are arranged on the upper and lower sides. The heat exchanging portion 39 includes a plurality of tubes 37 and radiating fins 38. The plurality of tubes 37 couple the auxiliary tanks 35 and 36 to each other. The radiating fins 38 are arranged around the tubes 37. The coolant water in the upper auxiliary tank 35 is cooled by air that passes through the radiating fins 38 when flowing toward the lower auxiliary tank 36 through the tubes 37. As shown in FIGS. 3 and 4, the upper auxiliary tank 35 in each of the core units 31 to 33 is arranged at the substantially same height as the upper main tank 15. As for the positional relationship from directly above between the upper auxiliary tank 35 and the upper main tank 15, with reference to the front view in FIG. 3 and the side view in FIG. 4, the lower surfaces of the upper auxiliary tank 35 and the upper main tank 15 are arranged at the substantially same height as each other, and the upper surface of the upper main tank 15 is arranged higher than the upper surface of the upper auxiliary tank 35. This positional relationship allows the upper auxiliary tank 35 and the upper main tank 15 to vertically overlap each other in the front view, and additionally ensures the head pressure for the coolant water. Coolant water inlets 40 (discussed later), and the coolant water outlets 21, 22 and 23 are arranged at the same height as each other.

As shown in FIG. 2, a rear plate 35a composes the rear surface of each upper auxiliary tank 35, and has a coolant water inlet 40 that extends straightly rearward. The coolant water inlets 40, and the coolant water outlets 21, 22 and 23 have a male hose coupling shape. A coolant water inlet reinforcing plate 41 is mounted on the outer periphery of the coolant water inlet 40. The coolant water inlet reinforcing plate 41 is fixed on the radiator frame 18. The coolant water inlets 40 of the first, second and third core units 31, 32 and 33 are connected to the first, second and third coolant water outlets 21, 22 and 23, respectively, via rubber hoses 42. Thus, the coolant water in the upper main tank 15 is distributed to the core units 31 to 33. Each of the coolant water outlets 21, 22 and 23, the corresponding rubber hose 42, and the corresponding coolant water inlet 40 are straightly connected to each other so that the rubber hose 42 is connected as a straight pipe without being bent.

As shown in FIG. 3, a lower main tank coupling port 43 is arranged on a bottom plate of each lower auxiliary tank 36, and extends downward. The lower main tank coupling ports 43 are detachably coupled to intakes (not shown) that are formed on the lower main tank 16.

As shown in FIG. 2, the radiator frame 18 is pivotally mounted to the vehicle body frame 9 by a pair of supporting shafts 18a that are arranged on the upper ends of the radiator frame 18 on both the right and left sides. The core units 31 to 33 are secured to the radiator frame 18 by rubber mount supporting devices 45 that are arranged above the core units 31 to 33. As shown in FIG. 4, the lower main tank 16 is secured to the vehicle body frame 9 by rubber mount supporting devices 46 that are arranged in front of the lower main tank 16. Thus, it is possible to firmly keep the arrangement of the radiator core 17 and the lower main tank 16 relative to the vehicle body frame 9, and to prevent that vibration and shock from the vehicle body frame 9 side are directly applied to the radiator core 17 and the lower main tank 16.

As shown in FIGS. 2 and 3, the upper main tank 15 is secured to the vehicle body frame 9 by rubber mount supporting devices 47 that are arranged on the right and left sides of the upper main tank 15. Thus, it is possible to firmly keep the arrangement of the upper main tank 15 relative to the vehicle body frame 9, and to prevent that vibration and shock from the vehicle body frame 9 side are directly applied to the upper main tank 15.

As shown in FIG. 4, an exterior cover 50 composes the roof of the engine compartment 6, and includes an engine hood 51 and a radiator hood 52. The engine hood 51 mainly covers the engine 4. The radiator hood 52 mainly covers the radiator 5. The upper main tank 15 is arranged at a position in the front-and-rear direction where the rear end portion of the radiator hood 52 overlaps the engine hood 51, and at a position from directly above that is spaced at a certain gap S away from the engine hood 51.

In the radiator according to this embodiment, as shown in FIGS. 3 and 4, the upper auxiliary tank 35 in each of the core units 31 to 33 is arranged at the substantially same height as the upper main tank 15. Also, the coolant water inlet 40 of the upper auxiliary tank 35 in each of the core units 31 to 33 is arranged at the substantially same height as the coolant water outlets 21 to 23 of the upper main tank 15. As shown in FIG. 2, the coolant water inlets 40 are connected to the coolant water outlets 21 to 23 via the rubber hoses 42. Accordingly, piping space between the upper main tank 15 and the upper auxiliary tanks 35 can be unnecessary that is required above the upper auxiliary tank 35 in the known radiator. Also, the upper main tank 15 is spaced away from the core units 31 to 33 not to overlap the core units 31 to 33 in the plan view. This arrangement can prevent that the coolant water conduit pipe from the engine 4 to the upper main tank 15 is arranged above the upper auxiliary tanks 35. For this reason, even in the case where the radiator according to the present invention has the same entire height as the known module type radiators 100 and 100A, the height of core units 31 to 33 can be greater. Therefore, it is possible to improve the cooling performance of the radiator 5.

The “coolant water conduit pipe” in the embodiments of the present invention corresponds each of the coolant water conduit pipes 60 that include the coolant water outlets 21, 22 and 23, the coolant water inlets 40, and the rubber hoses 42.

Also, since the coolant water inlet 20 for feeding coolant water into the upper main tank 15 is arranged in the lower surface of the upper main tank 15, the coolant water is fed from the bottom of the upper main tank 15. Therefore, it is possible to effectively prevent air entrainment into the coolant water, and to effectively prevent degradation of the cooling performance of the radiator 5.

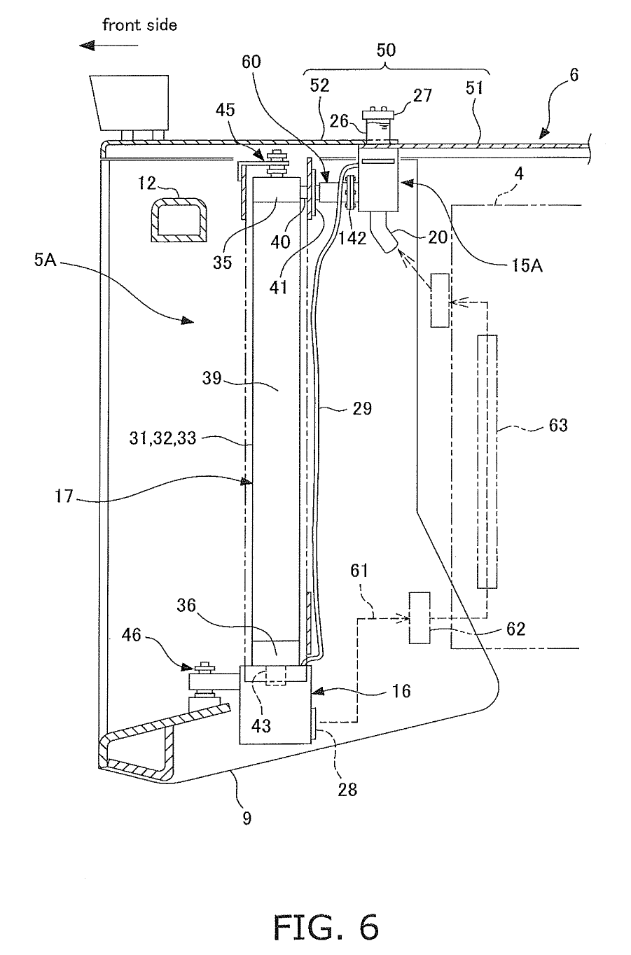

FIG. 6 is an illustrative view of a radiator according to a modified embodiment. In this modified embodiment, the same components as or components similar to the components in the foregoing embodiment are attached with the same reference numerals and their description is omitted. The following description will mainly describe its configuration different from the foregoing embodiment.

In this modified embodiment, a part of the front part of the engine hood 51 serves as the upper plate 15d of the upper main tank 15 in the foregoing embodiment so that the upper main tank 15A is adopted that is configured integrally with the engine hood 51. According to the radiator 5A of this modified embodiment, the height of the core units 31 to 33 can be increased by the gap S (see FIG. 4) between the upper main tank 15 and the engine hood 51 in the foregoing embodiment. For this reason as compared with the radiator 5 according to the foregoing embodiment, it is possible to further improve the cooling performance.

In addition, as shown in FIG. 6, single-flange portions 142 may be used for coupling the upper main tank 15 and the upper auxiliary tank 35.

The radiators according to the embodiment and its modified embodiment have been described. However, the present invention is not limited to the configurations described in the embodiment and its modified embodiment. Various changes and modifications can be made without departing from the spirit of the present invention.

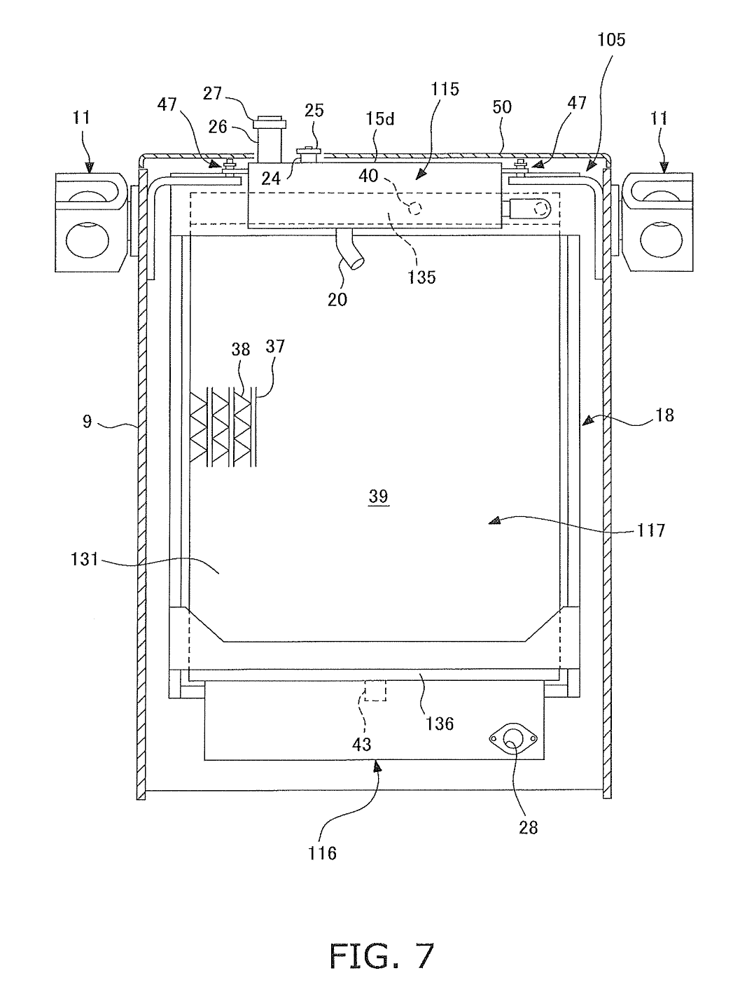

For example, as shown in FIG. 7, the present invention can be also applied not to the module type radiator but to a unitary type radiator 105. The radiator 105 includes a core unit 131 that includes a single radiator core 117 that is interposed between upper and lower auxiliary tanks 135 and 136 that are arranged on the upper and lower sides. The core unit 131 is connected to the upper main tank 115 and the lower main tank 116 in proximity to the upper and lower ends.

In the foregoing embodiment and its modified embodiment, the module type radiator according to the present invention has been illustratively applied to the bulldozer. However, the present invention is not limited to this. Needless to say, the radiator according to the present invention can be applied to work vehicles such as a hydraulic excavator and a wheel loader.

A radiator according to the above described embodiments has an effect in that its cooling performance can be effectively improved without increasing the entire size of the radiator. For this reason, the radiator according to the above described embodiments can be widely applied to radiators that are installed not only in work vehicles such as construction equipments but also in various types of machines.

1. A radiator comprising:
a heat exchanger;
an upper auxiliary tank that is mounted on an upper surface of said heat exchanger;
a lower auxiliary tank that is mounted on a lower surface of said heat exchanger so that said heat exchanger is interposed between the lower auxiliary tank and said upper auxiliary tank;
an upper main tank that is arranged at the substantially same height as said upper auxiliary tank and is arranged at an offset position relative to said upper auxiliary tank not to overlap said upper auxiliary tank in the plan view, the upper main tank being connected to said upper auxiliary tank via a coolant water conduit pipe, the upper main tank having a coolant water inlet on a lower surface thereof; and
a lower main tank that is arranged under said upper main tank at an offset position relative to said upper main tank in the plan view, the lower main tank being connected to said lower auxiliary tank.

2. The radiator according to claim 1, wherein
the lower surface of said upper main tank is arranged at the substantially same height as the lower surface of said upper auxiliary tank, and the upper surface of said upper main tank is arranged at a higher position than the upper surface of said upper auxiliary tank.

3. The radiator according to claim 1, wherein
said upper main tank has a coolant water outlet that discharges coolant water via said coolant water conduit pipe, and said upper main tank further includes a baffle that is arranged in proximity to said coolant water outlet to suppress passage of air bubbles through said coolant water outlet.

4. The radiator according to claim 1, wherein
said upper main tank is arranged at an offset position toward an engine side relative to said lower main tank.

5. The radiator according to claim 1, wherein
the radiator includes a plurality of core units, each of which includes said heat exchanger, said upper auxiliary tank and said lower auxiliary tank so that the radiator is configured in a module.

6. A radiator comprising:
a heat exchanger;
an upper auxiliary tank that is mounted on an upper surface of said heat exchanger;
a lower auxiliary tank that is mounted on a lower surface of said heat exchanger so that said heat exchanger is interposed between the lower auxiliary tank and said upper auxiliary tank;
an upper main tank that is arranged at the substantially same height as said upper auxiliary tank and is arranged at an offset position relative to said upper auxiliary tank not to overlap said upper auxiliary tank in the plan view, a side surface of the upper main tank being connected to a side surface of said upper auxiliary tank via a coolant water conduit pipe; and
a lower main tank that is arranged under said upper main tank at an offset position relative to said upper main tank in the plan view, the lower main tank being connected to said lower auxiliary tank.

7. The radiator according to claim 6, wherein
the radiator includes a plurality of core units, each of which includes said heat exchanger, said upper auxiliary tank and said lower auxiliary tank so that the radiator is configured in a module.

8. The radiator according to claim 6, wherein
said coolant water conduit pipe is a straight pipe.

9. The radiator according to claim 6, wherein
the radiator is installed in a vehicle, and said upper main tank is mounted to a vehicle body frame that composes a frame of said vehicle.

10. The radiator according to claim 6, wherein
the radiator is accommodated in an engine compartment of a vehicle, and said upper main tank is configured integrally with an exterior cover that composes a roof of said engine compartment.
